(19) United States
(12) Patent Application Publication
(10) Pub. No.: US 2018/0150043 A1
(43) Pub. Date: May 31, 2018

(54) CYBER-PHYSICAL SYSTEM MODEL FOR MONITORING AND CONTROL

(71) Applicant: United States Department of eNERGY, Washington, DC (US)

(72) Inventors: Dave Tucker, Core, WV (US); Lawrence Shadle, Morgantown, WV (US); Roy Long, Sugar Land, TX (US)

(21) Appl. No.: 15/813,107

(22) Filed: Nov. 14, 2017

Related U.S. Application Data
(60) Provisional application No. 62/421,580, filed on Nov. 14, 2016.

(51) Int. Cl. G05B 17/02

(52) U.S. Cl. CPC G05B 17/02; H04L 63/1441

(57) ABSTRACT

Materials, methods to prepare, and methods for evaluating and controlling a multistage/networked system. The system includes a power component; a controller coupled to the power component enabled for remote access through the internet; and sensor(s) coupled to one of the power component and the controller. The system further includes a cyber physical module (CPM) including hardware modules and virtual model coupled to one of the power components, controller and the sensor(s). The method includes receiving reading(s) from the power component and the sensor(s) using the controller; receiving reading(s) from the power component and the sensor(s) in real-time using the CPM; emulating dynamic components and unpredictable fluid dynamic components in the system using the CPM; evaluating fluid dynamic similarities to identify differences from a system map using the CPM; determining any deviations from the system map using the CPM; and breaking a connection to the remote access and asserting supervisory control over the system using the CPM.

### CROSS-REFERENCE TO RELATED APPLICATIONS

This application claims the benefit of and priority to U.S. Provisional Application 62/421,580 filed Nov. 14, 2016, which is incorporated herein by reference in its entirety.

### STATEMENT OF GOVERNMENT SUPPORT

The United States Government has rights in this invention pursuant to an employer/employee relationship between the inventors and the U.S. Department of Energy, operators of the National Energy Technology Laboratory.

### FIELD OF THE INVENTION

One or more embodiments consistent with the present disclosure relate to a cyber physical model to monitor and exert control over multistage networked plants and processes, such as a multistage chemical processing plant and power generation facilities for example.

### BACKGROUND

Processes controlled by Cyber Physical Systems, especially power generation facilities are vulnerable to cyber terrorism, as such facilities must maintain open access allowing them to receive load demands and enable reporting their system availability and status. For example, hardware components including sensors and actuators suffer fatigue due to the wear and tear of normal operations and/or manufacturing defects and they eventually fail. There is a real finite probability that these failures may occur at times outside the preventive maintenance schedule designed to avoid unscheduled upsets to power generation. Additionally, such physical access may allow terrorists or disgruntled employees to sabotage the system causing damage to the equipment and putting the stability of the electric grid at risk.

Existing numerical solutions used to monitor full scale systems are slow and the simulation of turbulence in the system are too inaccurate to make such processes effective in providing a high level of reliability. The simplifications required to make numerical approaches fast enough lack the accuracy and predictability required to be reliable. Embodiments of the present invention are used to address vulnerabilities in multi-stage and networked processes. In particular, this invention is used to address the risks associated with cyber-attacks, fault detection, and sabotage.

### SUMMARY

One or more embodiments relate to a method for evaluating and controlling a multistage/networked system. The method includes emulating dynamic components and unpredictable fluid dynamic components using one or more received readings in the multistate/networked system. The method further includes evaluating fluid dynamic similarities to identify differences from a multistate/networked system map; and determining any deviations from the multistate/networked system map using the cyber physical model.

Yet other embodiments relate to a method for evaluating and controlling a multistage/networked system. The method includes obtaining at least one set of rules that establish limits on power components of the multistage/networked system; and obtaining one or more timed readings from the power components. The method additional includes determining any deviations from the at least one set of rules to break a connection to remote access and assert supervisory control over the multistate/networked system.

Still other embodiments relate to a method for evaluating and controlling a multistage/networked system. The multistate/networked system includes a power component; a controller coupled to at least the power component and enabled for remote access through the internet/network; and at least one sensor coupled to at least one of the power components and the controller. A cyber physical module including hardware components and virtual models including an algorithm is coupled to at least one of the power component, the controller and the at least one sensor. The method includes receiving one or more readings from the power component and the at least one sensor using the controller; receiving one or more readings from the power components and the at least one sensor in real-time using the cyber physical model; emulating dynamic components and unpredictable fluid dynamic components in the multistate/networked system using the cyber physical model; evaluating fluid dynamic similarities to identify differences from a multistate/networked system map using the cyber physical model; determining any deviations from the multistate/networked system map using the cyber physical model; and breaking a connection to the remote access and asserting supervisory control over the multistate/networked system using the cyber physical model.

### BRIEF DESCRIPTION OF THE DRAWINGS

These and other features, aspects, and advantages of the multiple embodiments of the present invention will become better understood with reference to the following description, appended claims, and accompanied drawings where:

FIG. 1 depicts a block diagram of a multistage operating plant having a cyber physical module.

### DETAILED DESCRIPTION

The following description is provided to enable any person skilled in the art to use the invention and sets forth the best mode contemplated by the inventors for carrying out the invention. Various modifications, however, will remain readily apparent to those skilled in the art, since the principles of the present invention are defined herein specifically to monitor plant operations preventing unscheduled upsets among other faults. Existing numerical solutions used to monitor full scale systems are too slow, the simulations of turbulence are too inaccurate to make these processes effective in providing these high level of reliability. The simplifications required to make numerical approaches fast enough lack the accuracy and predictability required to be reliable.

Embodiments are used to address vulnerabilities to multi-stage and/or networked processes. In particular, the embodiments are used to address the risks associated with cyber-attacks, fault detection, and sabotage. More specifically, embodiments are expected to be used in safe-guarding multistage/networked systems such as commercial scale power plant as well as identifying deviations from optimal performance of the system, and scheduling required maintenance. Embodiments may be used in the highly critical infrastructure of highly sensitive production facilities such as those including utility scale combustion power plants, gasification-combined cycle, refinery operations, manufacturing of toxic chemicals and their intermediates, explosive productions, as well as other critical conversion, separation, and disposal processes.

More specifically, embodiments relate to the use of a cyber physical model (CPM) to monitor information from plant operations, interpret discrepancies in real time, and assess the process state for potential process instabilities. In one exemplary embodiment, the CPM consists of hardware components and virtual models that operate in real-time alongside the operating plant to emulate the processes taking place in the system while also assessing data for integrity and for any indication that the process has been comprised or is becoming unstable. The CPM operates completely isolated from any network connections eliminating the potential of being compromised by cyber-attacks. The sensors in the operating plant are monitored by the CPM in real time. These signals are interpreted by the virtual models into scaled conditions and flows as input to the CPM, thereby replicating the fluid dynamics and relevant effects from process chemistry at the process conditions. The fluid dynamic behavior resulting from subjecting the CPM are assessed and used to identify the process states in the operating plant. When a potential or imminent upset is recognized by the CPM, the operating plant is taken off the grid and the CPM takes control it making a smooth transition to a safe, idle condition.

For example, in a CPM developed for a hybrid power system, a micro-turbine is connected to cyber-physical fuel cell model to emulate the behavior of a full scale hybrid power plant. The influences of scale are used to adjust the flows in the CPM to accurately represent the operating plant. In such situations, the gas flows are scaled according to ideal gas law to account for plant size. These calculations are used to adjust the set points on actuators driving the hardware components, i.e., valves, in the CPM. Based upon this information, system identification algorithms or rules developed as part of the CPM are used to identify the process states and the associated operating map in the plant and make establishes limiters on the process changes. If these process states exceed predefined limits the plant is abruptly removed from the external and smoothly transitioned to the nearest safe idle state. This response is enacted in milliseconds before the system can respond to the questionable commands.

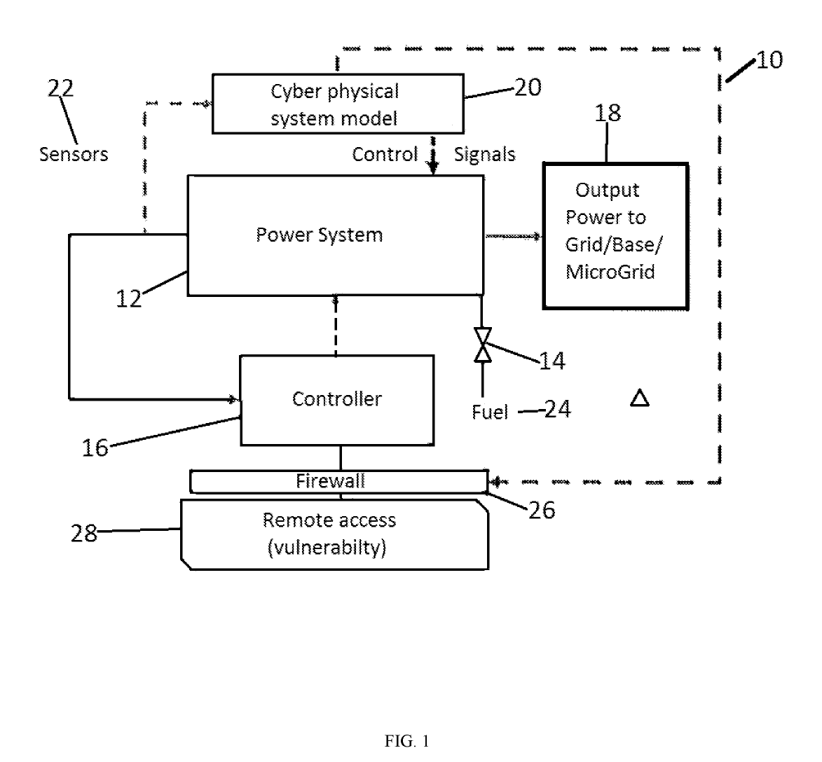

In FIG. 1 the operating plant 10 is depicted as a power generating system 12 including a fuel valve 14 (receiving fuel 24) and its controller 16 to produce the power output to the electric grid 18. CPM 20 monitors at least the plant 10 using the one or more plant sensors 22 as stimulus indicative of the operating state in the full scale plant 10. In the SOFC-turbine example this represents process conditions such as pressure, temperature, flows, and reactor concentrations. The operating plant 10 receives remote input from the electric grid 18 via controller 16.

Remote access 28 is enabled through its cyber security system or firewall 26. When the remote access point passes an infected signal into the plant controller 16 designed to disrupt or destroy the plant, such as completely opening or closing the fuel valve 14, it takes about 400 ms for the valve 14 to actuate and move to the requested position. In the CPM 20 the real-time models take these readings, convert them to the conditions in the hardware being used to emulate the plant. In the SOFC-turbine example, changes in the fuel flow 24 in the CPM 20 produce changes to the turbine speed within about 5 ms. Based upon the CPM 20 responses, its trajectory towards a new operating state, and its deviation from the stable operating map are identified within about 80 ms. The CPM 20 breaks the connection to the remote access and asserts supervisory control over the plant before it deviates from stable operation. Likewise fault detection in sensors 22 that fail and/or cause sabotage to the plant 10 may be rapidly detected and the CPM 20 may be used to take the plant 10 to stable and secure process states.

One or more embodiments of the present invention simplify and increase the detectability and accuracy of the numerical approaches that have been used previously. Embodiments of the present invention combine and couple hardware to emulate critical dynamic components and unpredictable fluid dynamics components in a multistage or networked system, and software to evaluate the fluid dynamic similarities, to emulate the predictable components, to identify the differences from the plant's operating map, and to exert supervisory control over it when necessary.

Embodiments measure the response of the critical components defining the critical process dynamic, it couples the responses of virtual components which effect its operating range but maintains hydrodynamic similarity with the full scale process plant using the combination to accurately mimic the processing unit in the full scale plant.

Determining the differences between the operating ranges in the CPM and the plant can be calculated in time sufficient to conduct real time system identification and evaluate process states and limiters.

Other embodiments may include variants using hardware that is a full scale duplication the entire process configuration to that only representing a small, but critical, single component. The hardware component may represent the smallest time scale necessary to capture the coupled system dynamics. These embodiments may be used for power systems as exemplified above; however, it may be applied by analogy to other multi-stage processes or networks that include transient applications that are not predictable. Examples include turbulent fluid flow, incipient fluidization, transient heat transfer, multiple reaction pathways, and biological processes, to name a few.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified.

All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

We claim:

1. A method for evaluating and controlling a multistage/networked system, comprising:
emulating dynamic components and unpredictable fluid dynamic components using one or more received readings in the multistate/networked system;
evaluating fluid dynamic similarities to identify differences from a multistate/networked system map; and
determining any deviations from the multistate/networked system map using the cyber physical model.

2. The method of claim 1 further comprising receiving one or more readings from a power component and at least one sensor, forming the received readings.

3. The method of claim 1 further comprising breaking a connection to a remote access and asserting supervisory control over the multistate/networked system.

4. The method of claim 1 wherein breaking a connection to a remote access and asserting supervisory control over the multistate/networked system comprises making a smooth transition to a safe, idle condition

5. The method of claim 1 further comprising using a cyber physical model.

6. The method of claim 1 wherein the one or more received readings comprises process conditions selected from the group consisting of pressure, temperature, flows, and reactor concentrations.

7. A method for evaluating and controlling a multistage/networked system, comprising:
obtaining at least one set of rules that establish limits on power components of the multistage/networked system;
obtaining one or more timed readings from the power components; and
determining any deviations from the at least one set of rules to break a connection to remote access and assert supervisory control over the multistate/networked system.

8. The method of claim 7 wherein obtaining the one or more timed readings comprises receiving one or more readings from a power component and at least one sensor.

9. The method of claim 7 further including emulating dynamic components and unpredictable fluid dynamic components using one or more received readings in and the at least one set of rules.

10. The method of claim 7 wherein breaking a connection to a remote access and asserting supervisory control over the multistate/networked system.

11. The method of claim 10 wherein breaking the connection to a remote access and asserting supervisory control over the multistate/networked system comprises making a smooth transition to a safe, idle condition.

12. The method of claim 7 wherein the one or more time readings comprises process conditions selected from the group consisting of pressure, temperature, flows, and reactor concentrations.

13. A method for evaluating and controlling a multistage/networked system, comprising:
the multistate/networked system comprising:
a power component;
a controller coupled to at least the power component and enabled for remote access through a network; and
at least one sensor coupled to at least one of the power component and the controller;
a cyber physical module including hardware components and virtual models having an algorithm operating thereon, the cyber physical module coupled to at least one of the power component, the controller and the at least one sensor;
the method comprising:
receiving one or more readings from the power component and the at least one sensor using the controller;
receiving one or more readings from the power component and the at least one sensor in real-time using the cyber physical model;
emulating dynamic components and unpredictable fluid dynamic components in the multistate/networked system using the cyber physical model;
evaluating fluid dynamic similarities to identify differences from a multistate/networked system map using the cyber physical model;
determining any deviations from the multistate/networked system map using the cyber physical model; and
breaking a connection to the remote access and asserting supervisory control over the multistate/networked system using the cyber physical model.
